(19) United States
(12) Patent Application Publication
(10) Pub. No.: US 2025/0356264 A1
(43) Pub. Date: Nov. 20, 2025

(54) METHODS AND SYSTEMS FOR QUANTUM SECURE FEDERATED LEARNING (FL) IN DISTRIBUTED ARTIFICIAL INTELLIGENCE (AI)

(71) Applicant: AT&T Intellectual Property I, L.P., Atlanta, GA (US)

(72) Inventors: Moshiur Rahman, Marlboro, NJ (US); Ayush Kumar, East Brunswick, NJ (US)

(73) Assignee: AT&T Intellectual Property I, L.P., Atlanta, GA (US)

(21) Appl. No.: 18/625,858

(22) Filed: Apr. 3, 2024

(51) Int. Cl. G06N 20/10

(52) U.S. Cl. CPC G06N 20/10

(57) ABSTRACT

Aspects of the subject disclosure may include, for example, transmitting, to a server, a request to participate in FL for an AI model, where a cloud system operates a first instance of the model and the device operates a second instance of the model, receiving, from the server, information relating to training of the second instance of the model, determining that computation(s) associated with the training are to be performed by a quantum computer, causing at least a portion of a local dataset to be provided to the quantum computer to perform the computation(s), receiving, from the quantum computer, output(s) of the computation(s), providing the output(s) to the server to enable aggregation of the output(s) with output(s) of other device(s) involved in the FL, obtaining aggregated data from the server, and utilizing the aggregated data to update the second instance of the model. Other embodiments are disclosed.

### FIELD OF THE DISCLOSURE

The subject disclosure relates to analytics-based software defined networking (SDN) and quantum computing-enabled federated learning (FL) in distributed artificial intelligence (AI).

### BACKGROUND

FL is the training of statistical models by remote participating clients, which may include devices or siloed data centers such as mobile phones, hospital servers, etc., where raw training data is generally kept localized. The learning task is solved by a loose federation of these participating clients that are coordinated by a central server. FL allows users to collectively reap the benefits of shared models trained from this rich set of data, without the need to centrally store all of it. Each client has a local training dataset, and computes an update to the current global model maintained by the server. Only this update (and not any of the local training data) is communicated to the server.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

One of the key challenges to designing an AI-based architecture for practical networking systems lies in the implementation of distributed data processing and learning across a massive number of heterogeneous devices. Training in heterogeneous and potentially massive networks introduces problems that require a fundamental departure from standard classical approaches for large-scale machine learning (ML), distributed optimization, and privacy-preserving data analysis. FL is an emerging distributed AI solution that enables data-driven AI and ML on a large volume of decentralized data that resides on mobile devices. FL has attracted significant interest due to its ability to perform model training and learning on heterogeneous and potentially massive networks, while keeping all of the data localized. FL-inspired distributed architectures are capable of fulfilling 6G's vision of ubiquitous AI. There are, however, specific challenges to its practical implementation:

(1) Heterogenous connectivity—Although recent experimental results show that it is unnecessary for every device to update the server in every round of model training, FL can only converge to an unbiased solution if all of the devices are equally likely to participate in the model training updates. In practical networking systems, however, mobile devices can experience frequent disconnections and can also decide to join and leave the training process depending on changing interests or service demands. This may lead to inferior models or biased training results.

(2) Optimizing Resource Consumption—The performance of FL is closely related to the availability and reliability of network connectivity as well as the computational capability of both servers and devices. In addition, communication and computing resource consumption can vary substantially for different AI algorithms. Quantifying resource consumption when FL is applied to different network topologies and services under different scenarios is still an open problem.

The subject disclosure describes, among other things, illustrative embodiments of a system architecture that enables analytics-based SDN and quantum computing-enabled FL in distributed AI. In exemplary embodiments, the system may employ one or more mechanisms under the policy of SDN to detect and keep track of the connectivity status of (e.g., all) clients, such as mobile devices, in real-time (or near real-time) during AI model training. In various embodiments, the system may be capable of adjusting bias(es) of trained AI models based on FL. In one or more embodiments, the system may leverage SDN-launched quantum computing that is embedded with fog servers for supporting FL in distributed AI.

In FL, each client may compute update(s) for the current global AI model maintained by the server, where (e.g., only) the update(s), and not any of the raw training data, are provided to the server. This enables decoupling of model training from the need for direct access to the raw training data. Since such updates are specific to improving the current AI model, neither the client nor the server may store them once the updates have been applied. For applications where the training objective can be specified on the basis of raw data that is available to each client, FL can significantly reduce privacy and security risks by limiting the attack surface to only the client device, rather than to both the client and the server.

Wireless technologies, such as 6G or beyond, Open Radio Access Network (O-RAN), etc., exhibit heterogenous connectivity with frequent device disconnections, which opens the door to inferior models and biased training results. Embodiments of the system leverage (e.g., on-demand) SDN, network analytics, and quantum-based fog computing to provide for a comprehensive, secure, dynamic, fast, and reliable FL framework that enables efficient learning even as wireless communications networks continue to evolve in the future. Indeed, implementation of the system mitigates security threats, issues relating to network connectivity failure, as well as computational resource starving of both servers and devices, thereby efficiently facilitating model training and ensuring the safety, reliability, and accuracy of training attributes and the final common model itself. Exemplary embodiments described herein thus advantageously address the core challenges in classical FL.

One or more aspects of the subject disclosure include a device, comprising a processing system including a processor, and a memory that stores executable instructions that, when executed by the processing system, facilitate performance of operations. The operations can include transmitting, to a server, a request to participate in federated learning (FL) for an artificial intelligence (AI) model, wherein a cloud system operates a first instance of the AI model, and wherein the device operates a second instance of the AI model. Further, the operations can include based on the transmitting, receiving, from the server, information relating to training of the second instance of the AI model. Further, the operations can include after the receiving, determining that one or more computations associated with the training are to be performed by a quantum computer. Further, the operations can include based on the determining, causing at least a portion of a local dataset accessible to the device to be provided to the quantum computer to perform the one or more computations. Further, the operations can include receiving, from the quantum computer, at least one output of the one or more computations. Further, the operations can include providing the at least one output to the server, wherein the providing enables the server to aggregate the at least one output with one or more other outputs provided by one or more other devices involved in the FL. Further, the operations can include obtaining aggregated data from the server based on the providing. Further, the operations can include utilizing the aggregated data to update the second instance of the AI model.

One or more aspects of the subject disclosure include a non-transitory machine-readable medium, comprising executable instructions that, when executed by a processing system including a processor, facilitate performance of operations. The operations can include receiving, from a device, a request to participate in federated learning (FL) for an artificial intelligence (AI) model, wherein a cloud system operates a first instance of the AI model, and wherein the device operates a second instance of the AI model. Further, the operations can include based on the receiving, accessing a software defined network (SDN) controller to verify authenticity of the device. Further, the operations can include responsive to the accessing, obtaining an indication from the SDN controller that the device has been verified. Further, the operations can include based on the obtaining, transmitting, to the device, information relating to training of the second instance of the AI model, wherein the transmitting causes the device to determine whether one or more computations associated with the training are to be performed by a quantum computer, cause at least a portion of a local dataset accessible to the device to be provided to the quantum computer to perform the one or more computations based on a determination that the one or more computations are to be performed by the quantum computer, and receive at least one output of the one or more computations from the quantum computer. Further, the operations can include after the transmitting, receiving the at least one output from the device. Further, the operations can include aggregating the at least one output with one or more other outputs provided by one or more other devices involved in the FL, resulting in aggregated data. Further, the operations can include sending the aggregated data to the device, thereby enabling the device to update the second instance of the AI model.

One or more aspects of the subject disclosure include a method. The method can comprise transmitting, by a processing system of a device including a process, and to a fog server, a request to participate in federated learning (FL) for an artificial intelligence (AI) model, wherein a cloud system operates a first instance of the AI model, and wherein the device operates a second instance of the AI model. Further, the method can include based on the transmitting, receiving, by the processing system, and from the fog server, information relating to training of the second instance of the AI model. Further, the method can include after the receiving, determining, by the processing system, that resources of a quantum computer are needed for at least some of the training. Further, the method can include based on the determining, causing, by the processing system, at least a portion of a local dataset to be provided to the quantum computer. Further, the method can include receiving, by the processing system, at least one computational output from the quantum computer associated with the at least some of the training. Further, the method can include providing, by the processing system, and to the fog server, the at least one computational output, wherein the providing enables the fog server to aggregate the at least one computational output with one or more other outputs provided by one or more other devices involved in the FL. Further, the method can include obtaining, by the processing system, aggregated data from the fog server based on the providing. Further, the method can include updating, by the processing system, the second instance of the AI model based on the aggregated data.

Other embodiments are described in the subject disclosure.

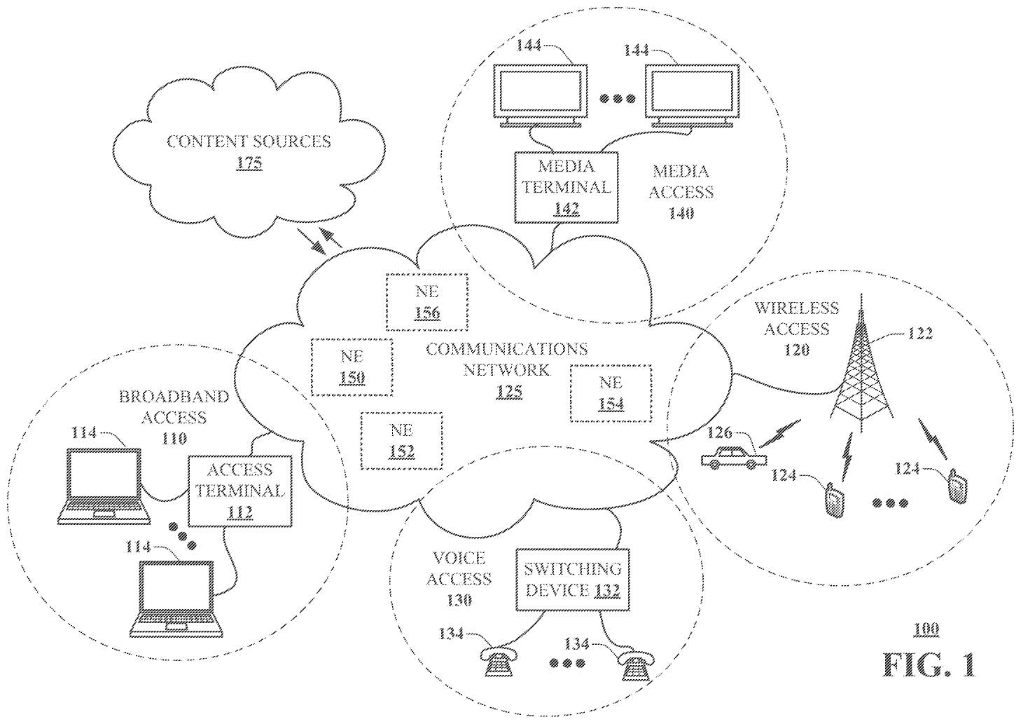

Referring now to FIG. 1, a block diagram is shown illustrating an example, non-limiting embodiment of a system 100 in accordance with various aspects described herein. For example, system 100 can facilitate, in whole or in part, analytics-based SDN and quantum computing-enabled FL in distributed AI. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The following is a description of an example FL-based architecture that addresses some or all of the aforementioned challenges of classical FL, including those related to security, disconnection detection, and the need for high speed computation services for distributed edge (e.g., fog) devices and end devices. As described in more detail below, the architecture may feature SDN functionality, analytics functionality, a central quantum computer, and distributed fog servers that may have logical interfaces with the quantum computer. As will be understood from the following description, the architecture may enable a large number of devices associated with different services to coordinate with one another to (e.g., jointly) construct/train a common AI model based on locally collected datasets. The network architecture can facilitate FL for various types of AI applications, such as those for image classification, next-word prediction, voice recognition, anomaly detection, and so on.

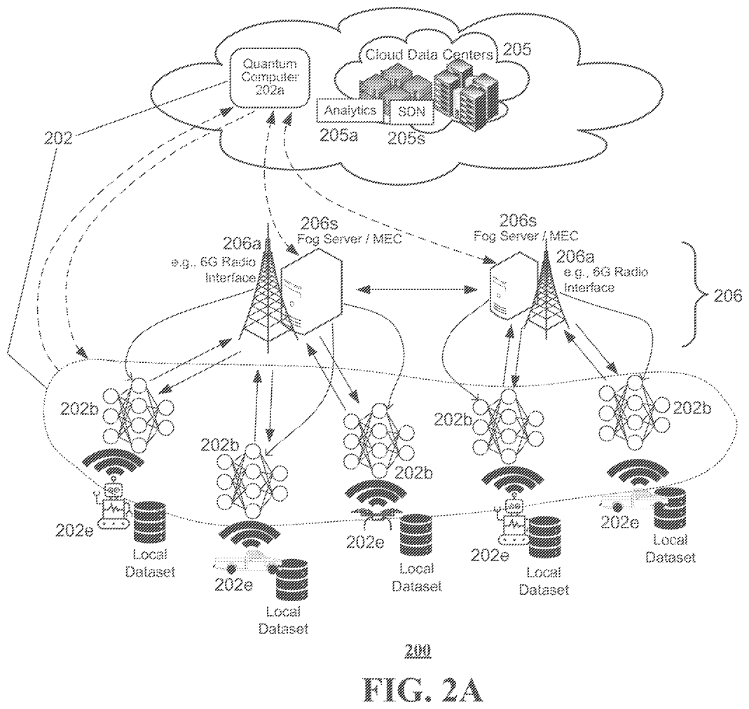

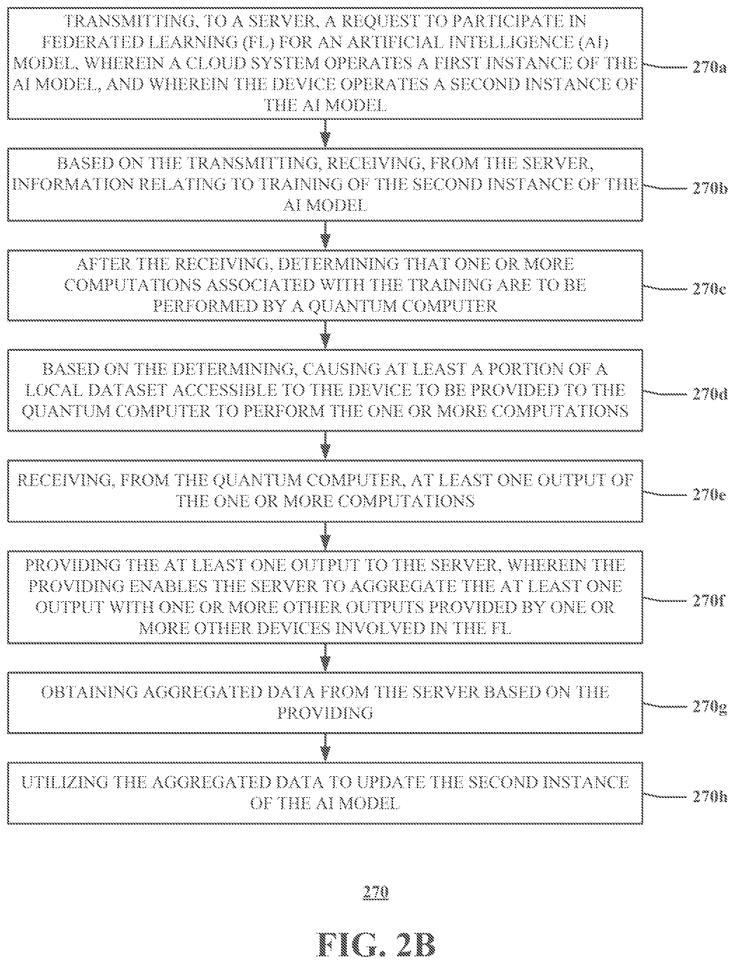

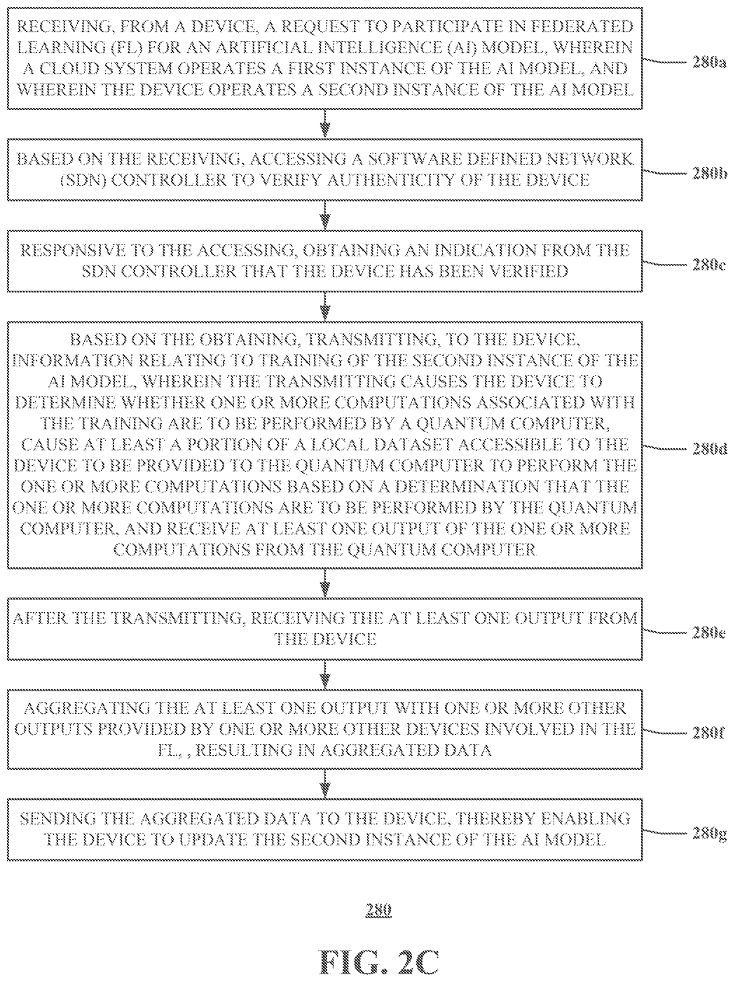

FIG. 2A is a block diagram illustrating an example, non-limiting embodiment of a system 200 functioning within, or operatively overlaid upon, the communications network 100 of FIG. 1 in accordance with various aspects described herein. As shown in FIG. 2A, the system 200 may include a quantum entanglement/signaling network 202, a cloud system 205, an access network 206, and end devices (or clients) 202e.

The quantum network 202 may include a quantum computer 202a and multiple quantum entanglement nodes (QEN) s 202b. In exemplary embodiments, the quantum computer 202a may provide (e.g., fast and on-demand) computation-related services for end devices 202e and/or fog servers 206s. The quantum computer 202a and the QENs 202b may be composed of certain materials that are kept at very low temperatures, such that electrons therein, for instance, behave as superconductors (moving through the materials with no resistance). This enables precise control of the electrons by using microwave photons to fixate or alter them, and allows for readouts of their positions for information. Whereas a classical processor operates using binary bits, the quantum computer 202a and QENs 202b may operate using qubits. Qubits can be placed in superposition to create multi-dimensional spaces that support the use of multi-dimensional quantum algorithms to solve complex problems. Qubits can also be entangled with one another such that the behavior of one qubit directly “impacts” another. Quantum teleportation is the communication functionality that allows the “transmission” of qubits without actually physically transferring the particle that stores the qubits. To implement quantum teleportation, a pair of parallel resources is needed—i.e., two classical bits must be sent from the source to the destination and an entangled pair of qubits must be generated and shared between the source and the destination. Because of this, quantum teleportation involves two parallel communication links—a classical one for transmitting the two classical bits and a quantum one for entanglement generation and distribution. For instance, in one or more embodiments, the quantum network 202 may include a network of networks, such as those based on optical fiber, satellite, and/or other transport means, for facilitating out-of-band quantum entanglement distribution between the quantum computer 202a and the QENs 202b.

In certain embodiments, some of the QENs 202b may be distributed among various devices of the system 200, such as remote node(s), hub(s) (e.g., propagation device(s) that couple a lower speed access network with a higher speed core network), switch(es), edge router(s) (ER(s)), and/or core router(s) (CR(s)). In various embodiments, QENs 202b may be included in or communicatively coupled to respective end devices 202e. Examples of end devices 202e include mobile devices 124, vehicles 126, robots, drones, display and television devices, home and business networks, Internet-of-Things (IoT) devices, video and audio devices, and so on. An end device 202e may be equipped with one or more transmitter (Tx) devices and/or one or more receiver (Rx) devices configured to communicate with, and utilize network resources of, the system 200.

In various embodiments, the access network 206 may include a wireless radio access network (RAN), a Wi-Fi network, and/or a wireline network. The access network 206 may include network resources, such as one or more physical access resources and/or one or more virtual access resources. Physical access resources can include access interfaces/base station(s) 206a (e.g., one or more eNodeBs, one or more gNodeBs, or the like), one or more satellites or uncrewed aerial vehicles (UAVs), one or more Gigabyte Passive Optical Networks (GPONs) or related components (e.g., Optical Line Terminal(s) (OLT), Optical Network Unit(s) (ONU), etc.), and/or the like. An access interface/base station 206a may employ any suitable radio access technology (RAT), such as 4G, 5G, 6G, or any higher generation RAT. One or more edge computing devices (e.g., Multi-access edge computing (MECs) devices or the like) may also be included in or associated with the access network 206.

Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network 206 may include any number/types of physical/virtual access resources and various types of heterogeneous cell configurations with various quantities of cells and/or types of cells.

In certain embodiments, the access network 206 may be implemented as a virtual access network, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations may be implemented as (e.g., passive) distributed radio elements connected to a centralized baseband processing pool. For instance, although not shown, certain components may be included in the access network 206—e.g., remote node(s), hub(s), switch(es), ER(s), etc.

In various embodiments, the access network 206 may include, or may be communicatively coupled to, the fog servers 206s. The fog servers 206s may include computing devices that are arranged in a decentralized manner, where data, applications, computational functionality, or the like are stored somewhere between the source of data and a cloud network. The fog servers 206s may serve as an extension of cloud computing at or closer to an edge of the overall network where data is generally generated/consumed. In some embodiments, a fog server 206s may be implemented in a virtual machine (VM) in a MEC server/device.

The cloud system 205 may include one or more cloud-based servers that are capable of facilitating FL in distributed AI. As depicted, the cloud system 205 may include, or may be communicatively coupled to, the quantum computer 202a as well as one or more server devices (e.g., in one or more data centers) for managing, training, and/or storing AI models. In exemplary embodiments, the server devices may correspond to various entities, such as, for instance, individuals or businesses that need to manage, train, and/or deploy AI models in a distributed manner to various devices and that seek to leverage the FL architecture to implement this management/training/deployment. For instance, one or more server devices may implement an AI/ML system for controlling and collecting data relating to autonomous driving, drone deployment, etc.

As shown in FIG. 2A, the cloud system 205 may include the SDN system 205s for managing network connectivity for elements in the system 200, such as, for instance, the fog servers 206s, the quantum computer 202a, the QENs 202b, access interfaces 206a, etc. The cloud system 205 may also include analytics functionality 205a as well as anomaly/failure detection functionality (e.g., operating based on network events), some or all of which may have logical interfaces with the SDN system 205s.

The SDN system 205s may be implemented in an SDN controller. The SDN controller may allow the system 200 to separate control plane operations from data plane operations, and may enable layer abstraction for separating service and network functions or elements from physical network functions or elements. In one or more embodiments, the SDN controller may coordinate networking and provisioning of applications and/or services. The SDN controller may manage transport functions for various layers within the system 200, and can access application functions for layers above the system 200. The SDN controller may provide a platform for network services, network control of service instantiation and management, as well as a programmable environment for resource and traffic management. The SDN controller may also permit a combination of real-time data from the service and network elements with real-time, or near real-time, control of a forwarding plane. In various embodiments, the SDN controller may enable flow set up in real-time, network programmability, extensibility, standard interfaces, and/or multi-vendor support. In one or more embodiments, the system 200 may include multiple SDN controllers (e.g., one or more for a front-haul link of the network, one or more for a back-haul link, etc.). In one or more embodiments, the SDN controller may be implemented using open source software (e.g., an application programming interface (API) written based on Python or the like) configured to manage network flows. In certain embodiments, the SDN controller may leverage an operating system (OS) (e.g., a 5G-EmPOWER OS providing OpenEmPOWER protocol or the like) configured to manage multiple heterogenous access networks and that provides management functions/services.

In various embodiments, the SDN system 205s may facilitate distribution of entanglement signaling or quantum link setup messages (via generation of entangled qubit Einstein-Podolsky-Rosen (EPR) pairs) between the quantum computer 202a and each of the QENs 202b such that the quantum computer 202a (or individual nodes thereof) are quantum-wise “connected” to the respective QENs 202b. Quantum connections can be made over any suitable channel, such as fiber, open air (e.g., satellite), etc. Connected quantum nodes allows for the physical implementation of various quantum-based functionalities, including, but not limited to quantum cryptography, quantum secret sharing, distributed quantum computations (QCs), Internet quantum networking, and so on. In one or more embodiments, the quantum computer 202a and/or the QENs 202b (or remote nodes that encompass them or that are connected thereto) may be equipped with EPR generation functionality for generating entanglement signaling (i.e., qubit entanglement generation). As an example, EPR generation functionality of the quantum computer 202a may be triggered (based on quantum entanglement distribution signals from the quantum network 202 and/or SDN system 205s) to provide entanglement signaling such that qubits in the quantum computer 202a become entangled with qubits in a given QEN 202b. In some embodiments, QENs 202b may be equipped with one or more interfaces (e.g., satellite-based interface or a logical interface) for sending data, requests, etc. to the quantum computer 202a and receiving computation outputs, responses, etc. from the quantum computer 202a. This enables end devices 202e (e.g., with fast access to the QENs 202b) to communicate with the quantum computer 202a for model training purposes. While there might be some transmission and propagation time needed, for instance, to send a computational request to the quantum computer 202a and to receive a computational output back from the quantum computer 202a, the overall time would generally be less than the time that it would otherwise take for the end device 202e to perform the task on its own, given the unparalleled computational capabilities of the quantum computer 202a over conventional computing devices.

In some embodiments, the system 200 may include a core network. In certain embodiments, some or all of the functionality of the cloud system 205, the quantum computer 202a, or both may be implemented in such a core network or may be accessible via such a core network. A core network may include various network devices and/or systems that provide a variety of functions. Examples of functions provided by, or included, in the core network include an access mobility and management function (AMF) configured to facilitate mobility management in a control plane of the system 200, a user plane function (UPF) configured to provide access to a data network, such as a packet data network (PDN), in a user (or data) plane of the system 200, a Unified Data Management (UDM) function, a Session Management Function (SMF), a policy control function (PCF), and/or the like. The core network may be in communication with one or more other networks (e.g., one or more content delivery networks (CDNs)), one or more services, and/or one or more devices. In one or more embodiments, the core network may include one or more devices implementing other functions, such as a master user database server device for network access management, a PDN gateway server device for facilitating access to a PDN, and/or the like. The core network may include various physical/virtual resources, including server devices, virtual environments, databases, and so on.

The following is a brief description of a non-limiting, example process for FL in distributed AI, using FIG. 2A as a reference. Assume that there are k QENs 202b/end devices 202e, referred to in this example process flow as participants 202b/202e, all with the same or a similar data structure and collaboratively using and/or training a shared AI/ML model in coordination with the parameter/cloud system 205. Each participant 202b/202e may operate a local instance of that AI/ML model (i.e., including its structure and layers along with its parameters, such as weights and/or biases). Also assume that the participants 202b/202e are honest whereas the cloud system 205 is honest-but-curious, and thus raw data in local datasets associated with the participants 202b/202e may not be shared with or leaked to the cloud system 205.

Initially, participant 202b/202e (e.g., each of the k participants) may evaluate received service request(s), service demand(s) or requirement(s), and/or connectivity condition(s) to determine whether to communicatively couple or register with a fog server 206s (e.g., via a wired connection or a wireless connection, such as a 6G radio interface or the like) to participate in FL for the shared AI/ML model. The participants 202b/202e may be triggered to perform the evaluation and determination based on a request or notification from the cloud system 205 regarding an FL training round. As an example, the participant 202b/202e may identify that the network connectivity (e.g., bandwidth or throughput) associated with an autonomous driving service satisfies a connectivity requirement by more than a threshold amount, and may determine to participate in the FL based on such an identification.

In a case where a participant 202b/202e connects to a fog server 206s to participate in the FL, the fog server 206s may, in turn, query the SDN 205s to verify the authenticity/legitimacy of the participant 202b/202e. In some embodiments, the verification may be based on a pre-built potential threat list that is stored in the analytics system 205a. Based upon verifying the authenticity/legitimacy of the participant 202b/202e, the SDN 205s may send an indication of the verification to the fog server 206s along with training information for the participant 202b/202e. The training information may include configuration data, data structure(s), AI/ML model sharing state data, initial AI/ML model parameters, and so on. If the SDN 205s cannot successfully verify the authenticity/legitimacy of a particular participant 202b/202e, the SDN 205s may send an indication of failed verification to the fog server 206s. For each verified participant 202b/202e, the fog server 206s may respond to that participant 202b/202e with the training information. The fog server 206s may thus select verified participants 202b/202e for the training and reject unverified ones. In some embodiments, the fog server 206s may limit the number of participants 202b/202e that can participate in the training based on a threshold—e.g., the first ten participants 202b/202e that the fog server 206s receives verification indications for from the SDN 205s.

Participants 202b/202e that receive the training information may each perform local computations with respect to the AI/ML model based on the training information and the participant's local dataset (e.g., collected data regarding autonomous driving conditions, etc.). Local training may, for instance, involve iteratively processing the local dataset through the local AI/ML model instance, computing gradients, and updating the AI/ML model parameters based on the gradients. In exemplary embodiments, a participant 202b/202e may determine whether to leverage the quantum computer 202a to facilitate model training depending on the complexity of the computations and/or depending on the computational resources required for the training. For instance, in a case where the participant 202b/202e determines that the resources needed for particular computation(s) associated with the training of the AI/ML model exceed a threshold (e.g., will drain the power of the device below a threshold), the participant 202b/202e may determine that assistance from the quantum computer 202a is needed. In such a case, the participant 202b/202e may send (e.g., via a predefined interface, such as a satellite interface or any other wired or wireless interface) some or all of the local dataset and any computational algorithm(s) (or information regarding such algorithm(s)) to the quantum computer 202a. In various embodiments, EPR generation functionality of the QEN 202b of or associated with the participant may generate entanglement with the quantum computer 202a. In some embodiments, the QEN 202b may be equipped or configured with one or more routing tables (which may be configured by the SDN controller) that the QEN and/or EPR generation functionality may utilize for signaling path routing table lookups. Here, the QEN and/or EPR generation functionality may choose the appropriate route between the QEN and the quantum computer 202a in accordance with the SDN's decided path. It will be understood and appreciated that the lookup table(s) may be updated as needed based on any changes that may be made to the quantum network elements and/or the links therebetween. In various embodiments, the lookup table(s) may also be utilized to “disentangle” the QEN 202b and the quantum computer 202a when quantum connections between the devices/systems are no longer needed so as to release the relevant resources in the quantum network. In any case, the quantum computer 202a may perform the required computations and return output(s) of the computations to the participant 202b/202e. The participant 202b/202e may then utilize the output(s) to facilitate computation of additional output(s), derive updated parameters for the AI/ML model, and/or the like. From the training, the participant 202b/202e may also send computation output(s) for, updates to, and/or feedback related to the AI/ML model (e.g., weights/bias values or the like) to the corresponding fog server 206s.

The fog server 206s may, based upon receiving sufficient outputs/updates/feedback (e.g., from a threshold number of participants 202b/202e, such as, for instance, seven out of ten participants), pre-process and aggregate the outputs/updates/feedback. In some embodiments, the fog server 206s may leverage the quantum computer 202a (e.g., by communicating with it over a predefined interface, such as a satellite interface or any other wired or wireless interface) to perform the aggregation if a larger set of outputs/updates/feedback (e.g., whose size exceeds a threshold) are involved. In some embodiments, the fog server 206s may be equipped or configured with one or more routing tables (which may be configured by the SDN controller) that quantum node(s) and/or EPR generation functionality of the fog server 206s may utilize for signaling path routing table lookups. Here, the quantum node(s) and/or EPR generation functionality may choose the appropriate route between the fog server 206s and the quantum computer 202a in accordance with the SDN's decided path. Similar to that described above, the quantum connection may be disentangled to release resources in the quantum network. Aggregated data may then be sent from the fog server 206s back to the participants 202b/202e for updating of the respective local AI/ML models and/or to the cloud system 205 for updating of the instance of the AI/ML model stored on the cloud system 205. The participants 202b/202e and/or the cloud system 205 may then utilize the aggregated data. For instance, each participant 202b/202e may update its respective AI/ML model using the aggregated data.

In some embodiments, the above-described process may be repeated in one or more training rounds—e.g., with the same or different set(s) of participants 202b/202e. The process may be repeated until the trained AI/ML model converges or one or more stopping criteria are met. In one or more embodiments, the cloud system 205 may transmit the updated AI/ML model to the SDN 205s and/or the analytics system 205a, for subsequent transmission to other entities (e.g., other cloud systems) for the benefit of these other entities or their associated users and/or for coordination of further training, thereby enabling access to and/or updating of the AI/ML model across a wider geographic area.

It is to be understood and appreciated that, although one or more of FIGS. 1 and 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, devices, computers, servers, interfaces, nodes, etc. may have been illustrated in one or more of FIGS. 1 and 2A as separate systems, devices, computers, servers, interfaces, nodes, etc., it will be appreciated that multiple systems, devices, computers, servers, interfaces, nodes, etc. can be implemented as a single system, device, computer, server, interface, node, etc., or a single system, device, computer, server, interface, node, etc. can be implemented as multiple systems, devices, computers, servers, interfaces, nodes, etc. Additionally, functions described as being performed by one system, device, computer, server, interface, node, etc. may be performed by multiple systems, devices, computers, servers, interfaces, nodes, etc., or functions described as being performed by multiple systems, devices, computers, servers, interfaces, nodes, etc. may be performed by a single system, device, computer, server, interface, node, etc.

FIG. 2B depicts an illustrative embodiment of a method 270 in accordance with various aspects described herein. In some embodiments, one or more process blocks of FIG. 2B can be performed by a participant device, such as the participant device 202e/202b.

At 270a, the method can include transmitting, to a server, a request to participate in federated learning (FL) for an artificial intelligence (AI) model, wherein a cloud system operates a first instance of the AI model, and wherein the device operates a second instance of the AI model. For example, the participant device 202e/202b can, similar to that described above with respect to the system 200 of FIG. 2A, perform one or more operations that include transmitting, to a server, a request to participate in federated learning (FL) for an artificial intelligence (AI) model, wherein a cloud system operates a first instance of the AI model, and wherein the device operates a second instance of the AI model.

At 270b, the method can include based on the transmitting, receiving, from the server, information relating to training of the second instance of the AI model. For example, the participant device 202e/202b can, similar to that described above with respect to the system 200 of FIG. 2A, perform one or more operations that include based on the transmitting, receiving, from the server, information relating to training of the second instance of the AI model.

At 270c, the method can include after the receiving, determining that one or more computations associated with the training are to be performed by a quantum computer. For example, the participant device 202e/202b can, similar to that described above with respect to the system 200 of FIG. 2A, perform one or more operations that include after the receiving, determining that one or more computations associated with the training are to be performed by a quantum computer.

At 270d, the method can include based on the determining, causing at least a portion of a local dataset accessible to the device to be provided to the quantum computer to perform the one or more computations. For example, the participant device 202e/202b can, similar to that described above with respect to the system 200 of FIG. 2A, perform one or more operations that include based on the determining, causing at least a portion of a local dataset accessible to the device to be provided to the quantum computer to perform the one or more computations.

At 270e, the method can include receiving, from the quantum computer, at least one output of the one or more computations. For example, the participant device 202e/202b can, similar to that described above with respect to the system 200 of FIG. 2A, perform one or more operations that include receiving, from the quantum computer, at least one output of the one or more computations.

At 270f, the method can include providing the at least one output to the server, wherein the providing enables the server to aggregate the at least one output with one or more other outputs provided by one or more other devices involved in the FL. For example, the participant device 202e/202b can, similar to that described above with respect to the system 200 of FIG. 2A, perform one or more operations that include providing the at least one output to the server, wherein the providing enables the server to aggregate the at least one output with one or more other outputs provided by one or more other devices involved in the FL.

At 270g, the method can include obtaining aggregated data from the server based on the providing. For example, the participant device 202e/202b can, similar to that described above with respect to the system 200 of FIG. 2A, perform one or more operations that include obtaining aggregated data from the server based on the providing.

At 270h, the method can include utilizing the aggregated data to update the second instance of the AI model. For example, the participant device 202e/202b can, similar to that described above with respect to the system 200 of FIG. 2A, perform one or more operations that include utilizing the aggregated data to update the second instance of the AI model.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C depicts an illustrative embodiment of a method 280 in accordance with various aspects described herein. In some embodiments, one or more process blocks of FIG. 2C can be performed by a fog server, such as the fog server 206s.

At 280a, the method can include receiving, from a device, a request to participate in federated learning (FL) for an artificial intelligence (AI) model, wherein a cloud system operates a first instance of the AI model, and wherein the device operates a second instance of the AI model. For example, the fog server 206s can, similar to that described above with respect to the system 200 of FIG. 2A, perform one or more operations that include receiving, from a device, a request to participate in federated learning (FL) for an artificial intelligence (AI) model, wherein a cloud system operates a first instance of the AI model, and wherein the device operates a second instance of the AI model.

At 280b, the method can include based on the receiving, accessing a software defined network (SDN) controller to verify authenticity of the device. For example, the fog server 206s can, similar to that described above with respect to the system 200 of FIG. 2A, perform one or more operations that include based on the receiving, accessing a software defined network (SDN) controller to verify authenticity of the device.

At 280c, the method can include responsive to the accessing, obtaining an indication from the SDN controller that the device has been verified. For example, the fog server 206s can, similar to that described above with respect to the system 200 of FIG. 2A, perform one or more operations that include responsive to the accessing, obtaining an indication from the SDN controller that the device has been verified.

At 280d, the method can include based on the obtaining, transmitting, to the device, information relating to training of the second instance of the AI model, wherein the transmitting causes the device to determine whether one or more computations associated with the training are to be performed by a quantum computer, cause at least a portion of a local dataset accessible to the device to be provided to the quantum computer to perform the one or more computations based on a determination that the one or more computations are to be performed by the quantum computer, and receive at least one output of the one or more computations from the quantum computer. For example, the fog server 206s can, similar to that described above with respect to the system 200 of FIG. 2A, perform one or more operations that include based on the obtaining, transmitting, to the device, information relating to training of the second instance of the AI model, wherein the transmitting causes the device to determine whether one or more computations associated with the training are to be performed by a quantum computer, cause at least a portion of a local dataset accessible to the device to be provided to the quantum computer to perform the one or more computations based on a determination that the one or more computations are to be performed by the quantum computer, and receive at least one output of the one or more computations from the quantum computer.

At 280e, the method can include after the transmitting, receiving the at least one output from the device. For example, the fog server 206s can, similar to that described above with respect to the system 200 of FIG. 2A, perform one or more operations that include after the transmitting, receiving the at least one output from the device.

At 280f, the method can include aggregating the at least one output with one or more other outputs provided by one or more other devices involved in the FL, resulting in aggregated data. For example, the fog server 206s can, similar to that described above with respect to the system 200 of FIG. 2A, perform one or more operations that include aggregating the at least one output with one or more other outputs provided by one or more other devices involved in the FL, resulting in aggregated data.

At 280g, the method can include sending the aggregated data to the device, thereby enabling the device to update the second instance of the AI model. For example, the fog server 206s can, similar to that described above with respect to the system 200 of FIG. 2A, perform one or more operations that include sending the aggregated data to the device, thereby enabling the device to update the second instance of the AI model.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

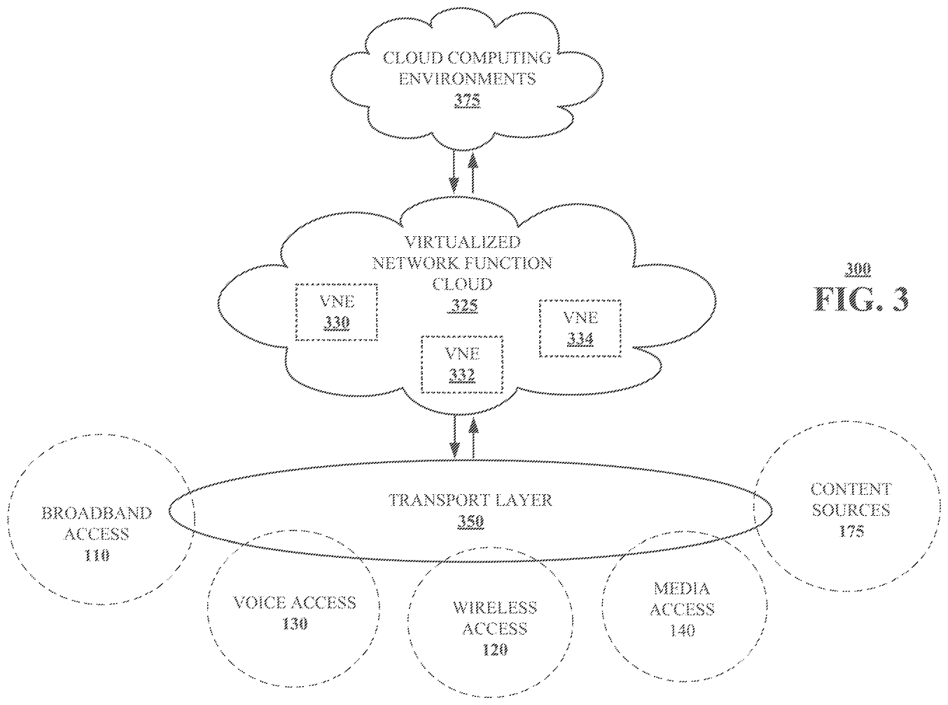

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and methods 270 and 280 presented in FIGS. 1, 2A, 2B, and 2C. For example, virtualized communications network 300 can facilitate, in whole or in part, analytics-based SDN and quantum computing-enabled FL in distributed AI.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

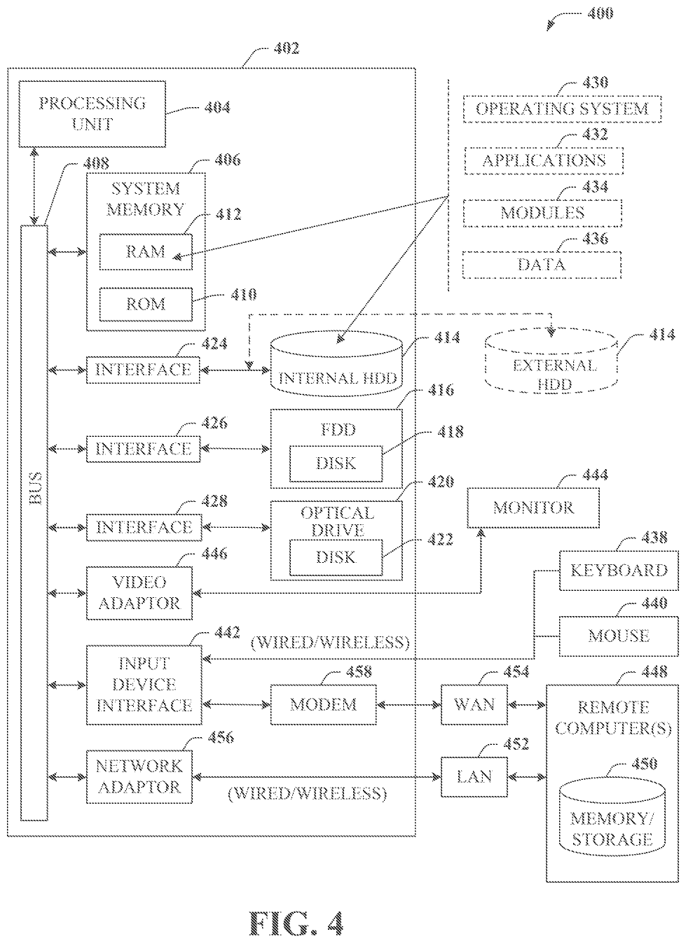

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, analytics-based SDN and quantum computing-enabled FL in distributed AI.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

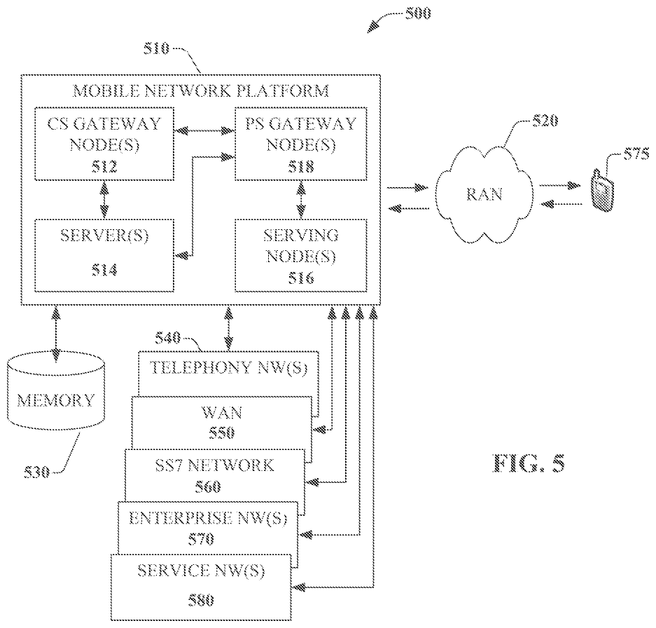

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, analytics-based SDN and quantum computing-enabled FL in distributed AI. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

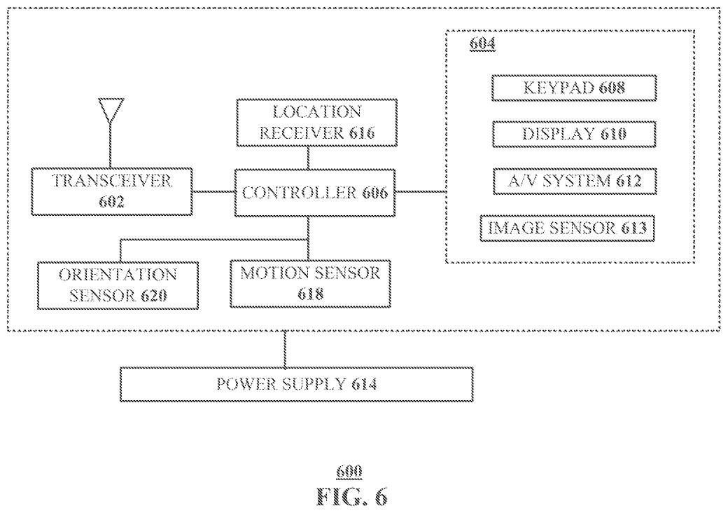

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, analytics-based SDN and quantum computing-enabled FL in distributed AI.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

In various embodiments, AI or ML algorithm(s) described herein may be configured to reduce any error in the derivations of associations/mappings, predictions of optimal (best) chains, appropriate action(s) to take, and so on. In this way, any error that may be present may be provided as feedback to the algorithm(s), such that the error may tend to converge toward zero as the algorithm(s) are utilized more and more.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
transmitting, to a server, a request to participate in federated learning (FL) for an artificial intelligence (AI) model, wherein a cloud system operates a first instance of the AI model, and wherein the device operates a second instance of the AI model;
based on the transmitting, receiving, from the server, information relating to training of the second instance of the AI model;
after the receiving, determining that one or more computations associated with the training are to be performed by a quantum computer;
based on the determining, causing at least a portion of a local dataset accessible to the device to be provided to the quantum computer to perform the one or more computations;
receiving, from the quantum computer, at least one output of the one or more computations;
providing the at least one output to the server, wherein the providing enables the server to aggregate the at least one output with one or more other outputs provided by one or more other devices involved in the FL;
obtaining aggregated data from the server based on the providing; and
utilizing the aggregated data to update the second instance of the AI model.

2. The device of claim 1, wherein the aggregated data are also utilized to update the first instance of the AI model in the cloud system.

3. The device of claim 1, wherein the device comprises a quantum node.

4. The device of claim 1, wherein the information comprises AI model configuration data, one or more AI model data structures, one or more AI model parameters, data regarding an AI model sharing state, or a combination thereof.

5. The device of claim 1, wherein the server comprises a fog server.

6. The device of claim 1, wherein no portion of the local dataset is provided from the device to the cloud system.

7. The device of claim 1, wherein the local dataset comprises raw training data for the AI model.

8. The device of claim 1, wherein the determining comprises determining that the one or more computations require more than a threshold amount of computational resources.

9. The device of claim 1, wherein the transmitting triggers the server to access a software defined network (SDN) system to verify authenticity of the device.

10. The device of claim 1, wherein the transmitting is performed in response to a receipt of a service request by the device.

11. A non-transitory machine-readable medium, comprising executable instructions that, when executed by a processing system including a processor, facilitate performance of operations, the operations comprising:
receiving, from a device, a request to participate in federated learning (FL) for an artificial intelligence (AI) model, wherein a cloud system operates a first instance of the AI model, and wherein the device operates a second instance of the AI model;
based on the receiving, accessing a software defined network (SDN) controller to verify authenticity of the device;
responsive to the accessing, obtaining an indication from the SDN controller that the device has been verified;
based on the obtaining, transmitting, to the device, information relating to training of the second instance of the AI model, wherein the transmitting causes the device to determine whether one or more computations associated with the training are to be performed by a quantum computer, cause at least a portion of a local dataset accessible to the device to be provided to the quantum computer to perform the one or more computations based on a determination that the one or more computations are to be performed by the quantum computer, and receive at least one output of the one or more computations from the quantum computer;
after the transmitting, receiving the at least one output from the device;
aggregating the at least one output with one or more other outputs provided by one or more other devices involved in the FL, resulting in aggregated data; and
sending the aggregated data to the device, thereby enabling the device to update the second instance of the AI model.

12. The non-transitory machine-readable medium of claim 11, wherein the processing system is implemented in a fog server.

13. The non-transitory machine-readable medium of claim 11, wherein the device comprises a quantum node.

14. The non-transitory machine-readable medium of claim 11, wherein the local dataset comprises raw training data for the AI model.

15. The non-transitory machine-readable medium of claim 11, wherein the device and the one or more other devices comprise a subset of devices selected by the processing system for participating in the FL.

16. A method, comprising:
transmitting, by a processing system of a device including a process, and to a fog server, a request to participate in federated learning (FL) for an artificial intelligence (AI) model, wherein a cloud system operates a first instance of the AI model, and wherein the device operates a second instance of the AI model;
based on the transmitting, receiving, by the processing system, and from the fog server, information relating to training of the second instance of the AI model;
after the receiving, determining, by the processing system, that resources of a quantum computer are needed for at least some of the training;
based on the determining, causing, by the processing system, at least a portion of a local dataset to be provided to the quantum computer;
receiving, by the processing system, at least one computational output from the quantum computer associated with the at least some of the training;
providing, by the processing system, and to the fog server, the at least one computational output, wherein the providing enables the fog server to aggregate the at least one computational output with one or more other outputs provided by one or more other devices involved in the FL;
obtaining, by the processing system, aggregated data from the fog server based on the providing; and
updating, by the processing system, the second instance of the AI model based on the aggregated data.

17. The method of claim 16, wherein the aggregated data are also utilized to update the first instance of the AI model in the cloud system.

18. The method of claim 16, wherein the processing system is implemented in a quantum node.

19. The method of claim 16, wherein no portion of the local dataset is provided from the device to the cloud system.

20. The method of claim 16, wherein the transmitting triggers the fog server to access a software defined network (SDN) system to verify authenticity of the device.
